(19) United States
(12) Patent Application Publication
(10) Pub. No.: US 2007/0216321 A1
(43) Pub. Date: Sep. 20, 2007

(54) Electronic Ballast with Life-Ended Protection

(76) Inventors: Lufan Yu, Fujian Province (CN); Wenping Xu, Fujian Province (CN)

Correspondence Address: GREER, BURNS & CRAIN, 300 S WACKER DR, 25TH FLOOR, CHICAGO, IL, 60606, US

(21) Appl. No.: 10/594,781

(22) PCT Filed: Jan. 26, 2005
(86) PCT No.: PCT/CN05/00113

§ 371 Date: Sep. 29, 2006

(30) Foreign Application Priority Data
Apr. 27, 2004 (CN) 200410036723.3

(51) Int. Cl. H05B 41/36

(52) U.S. Cl. 315/309

(57) ABSTRACT

An electronic ballast includes a rectifier and filter circuit, a DC/AC inverter circuit and a resonant circuit. An input of the rectifier and filter circuit is connected to an outside power supply, its output is connected to the inputs of DC/AC inverter circuit, an output of the DC/AC inverter circuit is connected to inputs of the resonant circuit, and an output of the resonant circuit is connected to a lamp. In addition, a feedback driver circuit and a filament current loop are connected to the lamp at its input. An input of the feedback driver circuit is connected to the filament current loop, and its output is connected to the control terminal of the DC/AC inverter circuit. Electrical signals of the filament current loop control the DC/AC inverter circuit drive the resonant circuit through the feedback driver circuit. The filament capacitor is disconnected from the lamp when the filament is broken.

### TECHNICAL FIELD OF THE INVENTION

The invention relates to an electronic ballast, and particularly to an electronic ballast with life-ended protection.

### BACKGROUND OF THE INVENTION

Conventional electronic ballasts include a rectifier and filter circuit, a DC/AC inverter circuit, a resonant circuit and the like. At present, however, some ballasts can go on work when the lamp filament is disconnected, at this time, it is possible to break and melt the lamp and to thereby cause hydrargyrum leakage, this is a serious hidden danger for safety.

### SUMMARY OF THE INVENTION

An object of the invention is to provide an electronic ballast with a function of life-ended protection, which can stop the ballast when the lamp filament is disconnected.

The electronic ballast according to the present invention has a rectifier and filter circuit, a DC/AC inverter circuit and a resonant circuit. An input of the rectifier and filter circuit is connected to an outside power supply, its output is connected to the inputs of DC/AC inverter circuit, an output of the DC/AC inverter circuit is connected to the inputs of resonant circuit, and an output of the resonant circuit is connected to a lamp. The electronic ballast also has a feedback driver circuit and a filament current loop connected to the lamp at its input. An input of the feedback driver circuit is connected to the filament current loop, and its output is connected to the control terminal of the DC/AC inverter circuit. Electrical signals of the filament current loop control the DC/AC inverter circuit to drive the resonant circuit through the feedback driver circuit.

A feedback drive transformer which is connected to the lamp filament current loop at its primary winding and to the input of the DC/AC inverter circuit at its secondary winding is used for the said feedback driver circuit.

A filament capacitor loop connected to the input of the feedback driver circuit at its output is used for the said lamp filament capacitor circuit.

A filament capacitor loop used for the said lamp filament capacitor circuit includes a capacitor and a thermal resistor in parallel. An input of the filament capacitor loop is connected to one end of the lamp, its output is connected to the primary winding of the feedback drive transformer, and an output of the primary winding is connected to the other end of the lamp. The secondary winding of the feedback drive transformer is connected for providing a drive power to bases of the two triodes of the DC/AC inverter circuit, respectively.

The present invention provides a feedback driver system for deriving the filament current from the filament capacitor, the filament capacitor is directly connected with the lamp filament, the filament capacitor is disconnected from the lamp when the filament is broken, thus, the feedback drive is stopped immediately, the DC/AC inverter circuit has no drive power and the system is stopped operating. There are various changes in detail circuit, but the effect may be obtained so long as the filament current feedback drive is combined.

### BRIEF DESCRIPTION OF DRAWINGS

FIG. 1 is a block diagram according to the present invention.

FIG. 2 is a schematic diagram of the first embodiment according to the present invention.

FIG. 3 is a schematic diagram of the second embodiment according to the present invention.

### EMBODIMENTS OF THE INVENTION

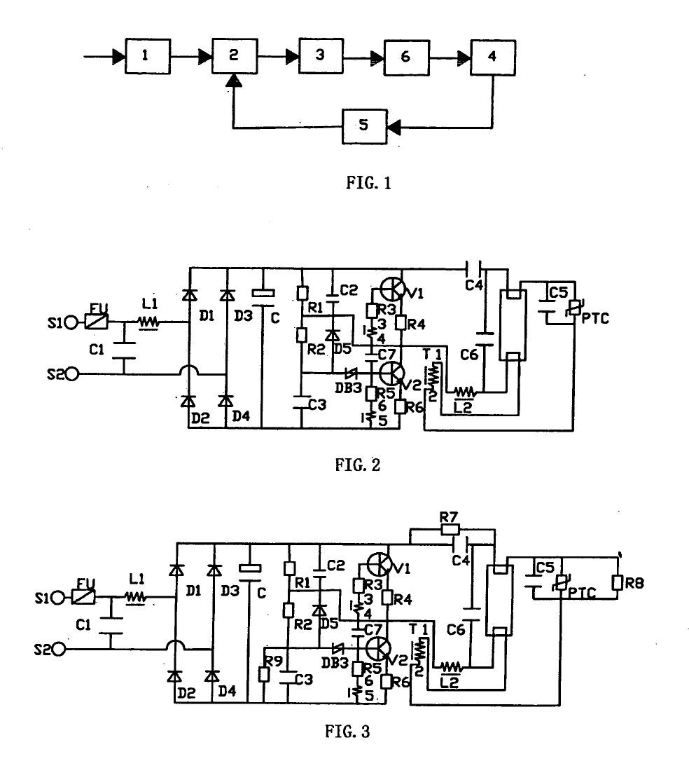

As shown in FIG. 1, the present invention is provided with a rectifier and filter circuit 1, a DC/AC inverter circuit 2, a LC series resonant circuit 3, a filament capacitor circuit 4, and a feedback driver circuit 5. An input of the rectifier and filter circuit 1 is connected to an outside power supply, its output is connected to an input of DC/AC inverter circuit 2, an output of the DC/AC inverter circuit 2 is connected to an input of the LC series resonant circuit 3, an output of the LC series resonant circuit 3 is connected to the lamp 6, the filament capacitor circuit 4 is connected to an input of the feedback driver circuit 5, and an output of the feedback driver circuit 5 is connected to the input of the DC/AC inverter circuit 2.

The feedback driver circuit may use a filament current feedback driver circuit comprised of a feedback drive transformer. The primary winding of the transformer is connected in series with the filament capacitor circuit and its secondary winding is connected to the input of the DC/AC inverter circuit. The embodiments of the present invention is given as follows.

### First Embodiment

As shown in FIG. 2, S1, S2 are inputs of power source. The rectifier and filter circuit is composed of a fuse FU, capacitors C and C1, an inductor L1, and rectifier diodes D1, D2, D3, and D4. The DC/AC inverter is composed of triodes V1, V2 and their peripheral devices. The LC series resonant circuit is composed of an inductor L2 and capacitors C4, C6. A capacitor C5 and a thermal resistor PTC connected in parallel are formed into the filament capacitor circuit that is connected to one end of the lamp at its input. The primary winding (primary turns) 1-2 of the feedback drive transformer T is connected in series with the filament capacitor circuit and is connected to the other end of the lamp, and the secondary windings (secondary turns) 3-4, 5-6 are connected to bases of the triodes V1, V2 of DC/AC inverter circuit for providing them with a drive power, respectively.

When the lamp filament is disconnected, the charging circuit for the capacitor C5 of filament capacitor circuit is turned off, and voltage across the capacitor C5 is approximate equal to 0 due to presence of the thermal resistor PTC. At the same time, the primary winding 1-2 of the feedback drive transformer T is powered off so as not to drive the secondary windings (secondary turns) 3-4, 5-6 connected to bases of the triodes V1, V2 of DC/AC inverter circuit, thereby the system stops operating. That is, when the lamp' life is terminated (the filament is disconnected), it may prevent the possibility of breaking and melting to cause hydrargyrum leakage, so the object of life-ended protection is obtained.

### Second Embodiment

As shown in FIG. 3, the DC/AC inverter circuit 2 is some different from the first embodiment, this is the most difference. The filament capacitor circuit is comprised of a capacitor C5, a thermal resistor PTC and a resistor 8 connected in parallel. The primary winding (primary turns) 1-2 of feedback drive transformer T is connected in series with the filament capacitor circuit and is connected to the other end of the lamp, and the secondary windings (secondary turns) 3-4, 5-6 are connected to bases of triodes V1, V2 of DC/AC inverter circuit for providing them with a drive power, respectively.

The invention gist explained by this embodiment is using the electrical signals of filament current loop 4 connected to the DC/AC inverter circuit 2 through the feedback driver circuit 5 to control oscillation of the resonant circuit 3 so that the life-ended protection is obtained. That is adaptable to various circuits.

The following are types and parameters of each main elements shown in FIG. 2:

Triodes V1, V2: 13003;

Diodes D1-D5: IN4007, DB3:

Resistors R1, R2: 330-680 KΩ; R3, R5: 5-20Ω; R4, R6: 0-1Ω;

Capacitors C1, C4: 22-100 NF; C2, C7: 0.1-2 NF; C3: 22 NF; C5: 1-3 NF; C6: 2-4 NF;

Thermal resistor PTC: 100Ω Φ5.

The following are types and parameters of each main elements shown in FIG. 3

Triodes V1, V2: 13003;

Diodes D1-D5: IN4007;

Resistors R2, R7, R8, R9: 330-680 KΩ; R3, R5: 5-20Ω; R4, R6: 0-1Ω;

Capacitors C1, C4: 22-100 NF; C2, C7: 0.1-2 NF; C3: 22 NF; C5: 1-3 NF; C6: 2-4 NF;

Thermal resistor PTC: 100Ω Φ5.

### THE INDUSTRIAL APPLICABILITY

The electronic ballast with life-ended protection according to the present invention is an improvement for the electronic ballast in prior art. It is mainly to select the feed back circuit and its signal sample points, the main elements used are all standard devices, the manufacture is simple, and a good industrial applicability is obtained.

1. An electronic ballast with life-ended protection comprising: a rectifier and filter circuit, a DC/AC inverter circuit and a resonant circuit, an input of the rectifier and filter circuit being connected to an outside power supply, an output of said rectifier and filter circuit being connected to inputs of the DC/AC inverter circuit, an output of the DC/AC inverter circuit being connected to inputs of resonant circuit, and an output of the resonant circuit being connected to a lamp, a feedback driver circuit and a filament current loop connected to the lamp at an input of said feedback driver circuit, an input of the feedback driver circuit being connected to the filament current loop, an output of said feedback driver circuit being connected to a control terminal of the DC/AC inverter circuit, electrical signals of the filament current loop controlling the DC/AC inverter circuit to drive the resonant circuit through the feedback driver circuit.

2. The electronic ballast with life-ended protection according to claim 1, wherein the feedback driver circuit further includes a feedback drive transformer connected to the lamp filament current loop at a primary winding of said transformer and to the input of the DC/AC inverter circuit at a secondary winding of said transformer.

3. The electronic ballast with life-ended protection according to claim 1, further including a lamp filament compacitor circuit having a filament capacitor loop connected to one end of the lamp at its input and to the input of the feedback driver circuit at its output.

4. The electronic ballast with life-ended protection according to claim 1, further including a filament capacitor loop used for a lamp filament capacitor circuit includes a capacitor and a thermal resistor in parallel, an input of the filament capacitor loop is connected to one end of the lamp, an output of said loop is connected to the primary winding of a feedback drive transformer, an output of a primary winding is connected to another end of the lamp, a secondary winding of the feedback drive transformer is connected for providing a drive power to bases of two triodes of the DC/AC inverter circuit, respectively.

5. The electronic ballast with life-ended protection according to claim 2 further including a filament capacitor loop used for a lamp filament capacitor circuit includes a capacitor and a thermal resistor in parallel, an input of the filament capacitor loop is connected to one end of the lamp, an output of said loop is connected to the primary winding of the feedback drive transformer, an output of the primary winding is connected to the other end of the lamp, the secondary winding of the feedback drive transformer is connected for providing a drive power to bases of two triodes of the DC/AC inverter circuit, respectively.
